(19) United States
(12) Patent Application Publication
(10) Pub. No.: US 2018/0036888 A1
(43) Pub. Date: Feb. 8, 2018

(54) METHOD OF MARKING OUTLINE OF LARGE SCALE GRAPHIC ELEMENT AND ROBOT FOR SUCH METHOD

(71) Applicants: Philipp IRNIGER, Shanghai (CH); SIKA TECHNOLOGY AG, Baar (CH)

(72) Inventors: Philipp IRNIGER, Shanghai (CN); Matthias BLEIBLER, Qingxizhen Dongguan (CN)

(73) Assignee: SIKA TECHNOLOGY AG, Baar (CH)

(21) Appl. No.: 15/501,679

(22) PCT Filed: Aug. 4, 2016
(86) PCT No.: PCT/CN2014/083621

§ 371 Date: Feb. 3, 2017

(51) Int. Cl. B25J 11/00; B25J 9/16; B25J 5/00; G05D 1/02

(52) U.S. Cl. CPC B25J 11/0075; G05D 1/0236; B25J 9/1676; B25J 9/161; B25J 5/007; Y10S 901/01

(57) ABSTRACT

An exemplary method of marking an outline of a graphic element on a surface site such as a roof, floor, road, airfield or sports ground or similar large scale surface, includes preparing outline data representing the outline of the graphic element; and feeding the outline data to a robot. The robot marks the outline of the graphic element on the surface site based on the fed outline data.

### TECHNICAL FIELD

The present invention relates to a method of marking an outline of a (large scale) graphic element on a surface site such as a roof, floor, road, airfield or sports ground (or similar large scale surface) according to claim 1, a method of providing a (large scale) graphic element according to claim 7 and a robot for marking an outline of a (large scale) graphic element on a surface site according to claim 8.

### TECHNICAL BACKGROUND

Often, large scale graphic elements (as e.g. logos or the like) have to be provided on surface sites such as flat roofs or industrial/commercial floors. One known method (typically used for providing a large scale graphic element on a roof) includes coloured sheet membranes. Via manual marking and/or plotters, an outline of the graphic element is marked onto the coloured sheet membrane. Several pieces are then cut manually along the outline, numbered, packed and brought to a job site. On the job site the pieces are unpacked, aligned and welded or adhered to the roof (roof membrane). A disadvantage of this method is that coloured membranes are expensive and the waste rate (due to cut-away portions) is rather high. Moreover, the process and installation is time and labour intensive. The overall costs are high.

Another method (typically used for floors) comprises the printing of a graphic element onto a foil which is then laminated into the floor built-up. However, such printing is only available in limited sizes (and therefore not suitable for very large graphic elements). Moreover, the lamination method does not work on all surfaces (e.g. on cement based floors such as dry-shake floors).

### SUMMARY

It is an object of the present invention to propose a method for simplifying the provision of large scale graphic elements on a surface site such as a roof, floor, road, airfield or sports ground. In particular, the costs and time consumption should be reduced.

A first aspect of the present invention is a method of marking an outline of a (large scale) graphic element on a surface site such as a roof, floor, road, airfield or sports ground (or similar large scale surface), comprising:
preparing outline data representing the outline of the graphic element,
feeding the outline data to a robot, wherein the robot marks the outline of the graphic element on the surface site based on the fed outline data.

A core idea of the invention is to mark the outline of the large scale graphic element directly on the surface site via a robot. The area within the outline can be filled with colour (e.g. by manually painting). In essence, the method can be carried out completely on site. This simplifies the process. Moreover, if just the area within the outline is filled with colour (paint), there is in principle no waste of coloured material. Nonetheless, it is possible to provide very large scale graphic elements. It is possible to cover an area of at least 1 m² or at least 5 m² or at least 50 m² or even at least 500 m². Two points of the outline which have the largest distance from each other (among all possible pairs of points) could be at least 1 m or at least 3 m, or at least 10 m or even at least 30 m.

The step of preparing outline data representing the outline of the graphic element may comprise converting graphic element data representing the graphic element itself into data representing the outline thereof. This can be done on a regular computer with corresponding software (in particular off-site). The graphic element may be pre-processed (by scaling of the graphic element to fit the surface site and/or by defining a starting point and/or by orientation and/or by definition of a blind path between discrete segments of the outline of the graphic element). Moreover, the data of the graphic element may be converted with a corresponding software to a file format readable by the (mobile) marking robot. In essence, as a first step, the given graphic element picture may be pre-processed. The picture may be converted from a colour-picture into a binary-picture including only the border lines (outline). Optionally, the area of the picture with an obstacle inside could be cut out manually in advance.

Preferably, the surface site is (substantially) plane (flat). It is preferred that the surface site extends horizontally or has a lower angle (e.g. less than 20° or less than 10° or less than 5°) with respective to the horizontal direction.

Preferably, the robot comprises position measuring means wherein the position measuring means measures the (absolute) position of the robot on the surface site. Such position measuring simplifies the process of marking the outline on the ground.

In an embodiment, the position measuring means comprises at least one light source, in particular a laser, measuring the distance to at least two, preferably at least three, further preferably at least four landmarks, in particular reflectors. Alternatively or in addition, the position measuring means measures the distance of the robot to at least two, preferably three, further preferably at least four landmarks, in particular reflectors. Alternatively or in addition, the position measuring means measures an angle defined by the position of the robot as vertex point and at least one pair, preferably at least two pairs, further preferably at least three (different) pairs of landmarks, in particular reflectors. For example, the pairs might be landmarks AB, BC, CD. In a preferred embodiment, the distance and/or angle may be measured by using light, in particular a laser. In particular, in such a case, the landmarks could be landmarks that are on or near to the surface site anyway or that may be provided in addition. Moreover, the contour of the environment may be used in order to determine the position of the robot. All in all, a simple determination of the (absolute and/or relative) position of the robot may be achieved.

In an embodiment, the position measuring means determines the position via triangulation, in particular laser triangulation, using predetermined positions of at least two, preferably at least three, further preferably at least four landmarks. The (laser) triangulation method is a comparatively simple and reliable method for measuring the position of the robot.

It is preferred, that the position measuring means measures not only the position of the robot but also the orientation thereof. This may be done by measuring at least two (or at least three or at least four) angles being defined by the position of the robot as vertex point and/or at least two (or at least three or at least four) pairs of landmarks (e.g. landmarks AB, BC, BD, DE).

The method includes preferably the placement of at least two, further preferably at least three, even further preferably at least four reflectors on the surface site. Such reflectors may be useful for determining the position of the robot during its movement (for example by laser triangulation).

In a preferred embodiment the largest distance between two points of the outline is at least 1 m, further preferably at least 3 m, even further preferably at least 10 m, even further preferably at least 30 m. As an alternative or in addition, the area between the outline may be at least 1 m², preferably at least 5 m², further preferably at least 50 m², even further preferably at least 500 m². In essence, the outline of very large graphic elements may be provided.

A further aspect of the invention is a method of providing a graphic element comprising the method of marking an outline of the graphic element of the predescribed kind and filling (in particular manually, e.g. by painting) the area between the outline with paint. Such method is very simple and allows the reduction of resources.

A further aspect of the invention is a robot for making an outline of a graphic element on a surface site such as a roof, floor, road, airfield or sports ground (or similar large scale surface), in particular according to the predescribed kind, comprising:
an input means for receiving outline data of the graphic element
an automatic driving unit for (an autonomous) moving of the robot along the outline of the graphic element
a position measuring means, in particular a laser triangulation sensor, for determining the robot position
a marking device, in particular printing device, for marking the outline on the surface site

Such robot allows an efficient and simple provision of an outline of a graphic element in order to provide a graphic element on the surface site (e.g. via manually painting).

A (maximum) speed of the robot is at least 0.01 m/s, preferably at least 0.03 m/s. An upper limit may be 0.3 m/s, preferably 0.15 m/s, further preferably 0.08 m/s. Such a speed allows a fast and reliable provision of the outline of the graphic element.

In an embodiment, the robot comprises a collision detection unit. Thereby, an interruption or even dysfunction of the robot can be avoided. The robot may comprise means for circumventing an object which is in the path of the robot. However, it is preferred that the robot signalises that there is danger of collision so that the user can deal with the object in the path of the robot or move the robot around the object.

Preferably the robot comprises a zero position and zero orientation tool, in particular at least one, preferably at least two point lasers and/or line lasers for (initially) positioning and orientating the robot on the surface site. By such a tool, the robot can be placed exactly on a reference point and aligned (oriented). In particular a line laser allows a simple zero orientation of the robot.

The robot may comprise a display and/or an input device (e.g. keyboard or touch panel or touchscreen) and/or an interface for transferring data, e.g. a USB interface, an Ethernet interface and/or a serial interface. Such features enhance the possibilities of handling the robot.

In a preferred embodiment the driving means of the robot comprises a plurality of wheels. One or more of the wheels may be turnable. Moreover, the driving means may comprise at least one motor, preferably electric motor in order to drive the robot (e.g. the wheels).

### BRIEF DESCRIPTION OF THE DRAWINGS

In the following, a preferred embodiment of the present invention is described with reference to the drawings. These show:

FIG. 1 A schematic drawing of a surface site and a robot:

FIG. 2 A schematic drawing for a method of determining the position and orientation of the robot.

### DETAILED DESCRIPTION OF THE EMBODIMENT

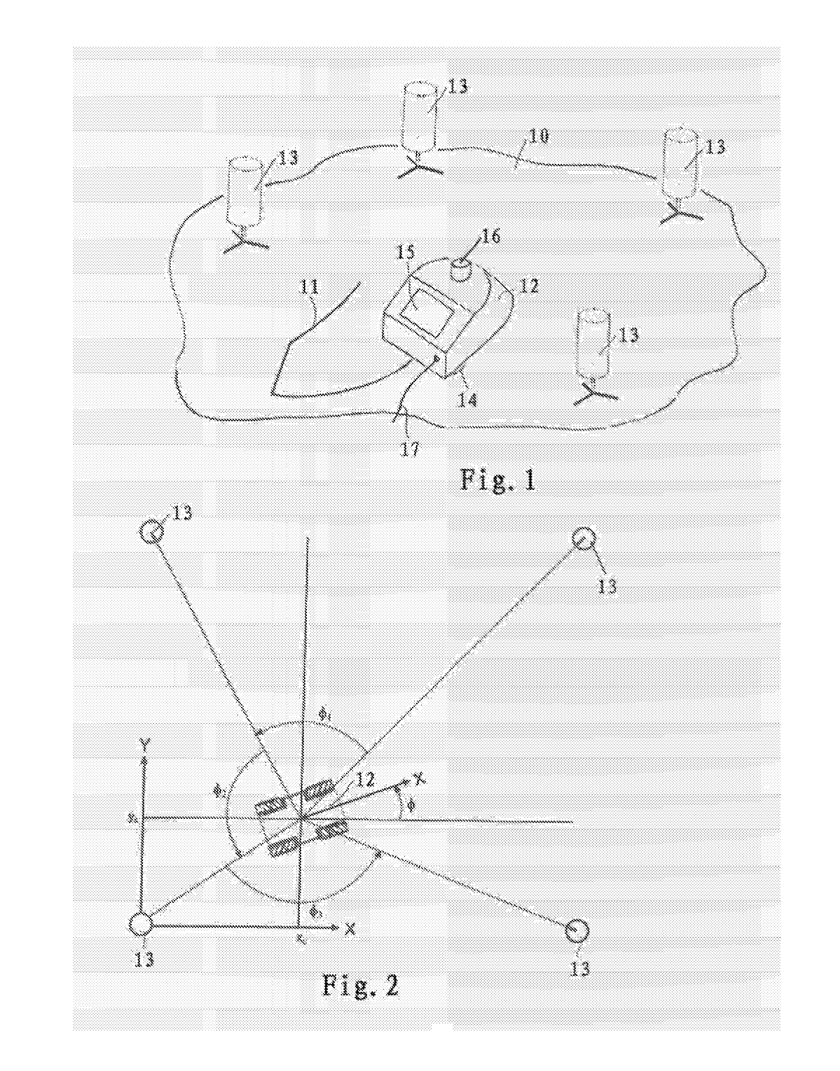

FIG. 1 shows a surface site 10 on which a part of an outline 11 of a graphic element has been marked by a robot 12. Moreover, reflectors 13 are placed on the surface site.

The robot 12 may comprise a (light weight) frame and wheels 14. Moreover, a touchscreen panel 15 (in general: input and display means) can be provided. Furthermore, the robot comprises a laser triangulation sensor 16 on the top. Reference sign 17 indicates a power supply line. Within the robot 12, a printer unit (not shown) is provided for printing the outline 11 on the surface site 10. Moreover (not shown in the figures), a steering and driving unit (including at least one turnable wheel) may be provided.

The method for providing the outline 11 of the graphic element comprises (in general) two phases. In a first phase (usually off-side; e.g. on a regular computer with adequate software) the graphic element is pre-processed (e.g. scaling of the graphic element to fit the (horizontal) surface site; definition of a starting point and a starting orientation; definition of a blind path between discrete segments of the outline of the graphic element) and converted with a customised software to a file format readable by a mobile marking robot.

In a second phase (preferably on side) the reflectors 13 are (randomly) placed onto the surface site 10 around the area to be marked with the graphic element. The (mobile) marking robot 12 is placed on a reference point and aligned (in a zero orientation). This is done by line lasers. After such initiation, the marking robot 12 starts moving along the predefined path using the (high frequency) laser triangulation sensor 16 to determine its position and for adjusting the steering and driving unit to move forward. While moving, the marking robot 12 marks the outline 11 of the graphic element using the printing unit. The display 15 on the robot 12 allows for a continuous process control and adjustments.

The principle of the laser triangulation sensor 16 is shown in FIG. 2. A rotating point laser is placed on top of the robot. This laser rotates 360° with a continuous speed (of e.g. 4 to 16 Hz, in particular 8 Hz). When passing a landmark (e.g. one of the reflectors 13), the laser beam is reflected back to the robot 12 and the robot 12 measures an angle φ₁, φ₂, φ₃ (see FIG. 2). By reading these angles and the distance of the reflectors, the sensor 16 is capable of calculating the robot's absolute position and orientation within the working area.

In general, the laser triangulation sensor 16 may be adapted to calculate the (absolute) position not only based on the reflector coordinates but also in addition by use of surrounding contours. Thereby, the sensor can at least estimate its position even if the reflectors are not visible. An optional (built-in) absolute length measurement can be used to realise a collision detection so that a collision may be avoided. The robot 12 may be smaller (in a packed state) than 0.5×0.8 m and/or lighter than 25 kg. The accuracy of the determination of the position may be better than +/−5 cm, preferably better than +/−3 cm. The movement of the robot 12 is preferably fully autonomous. If a collision is detected, a user input may be required (or the robot itself takes measures in order to avoid the collision). A maximum printing area may be 50×50 m. A marking line width may be 1-12 mm.

After drawing the outline of the graphic element by the robot, the graphic element can be finalised by a subsequent painting process. This can be rolling or spraying a coloured paint by hand, following the drawn outline.

The number of reflectors should be at least three. However, it is preferred to have at least four or even at least five reflectors. In such a case, if one or two reflectors are hidden, the robot 12 can still accurately determine its position.

The (mobile) robot 12 allows, in general, for a fast and accurate marking of the outline 11 of large graphic elements onto (in particular horizontal) surfaces such as flat roofs and floors. In combination with a manually applied, usually coloured coating, the costs for large graphic elements on surfaces such as flat roofs and floors are reduced compared to known methods. This reduction in costs can make graphic elements on surface sites (flat roofs) possible for almost every project. This is in line with the need of many owners to use their roof as a fifth façade considering the more and more widespread use of aerial map based applications on computer and mobile devices. If the invention is applied to a floor, this is even possible onto concrete floors (which is an entirely new application) for an accurately marking of the outline of a large scale graphic element. A particular advantageous use of the present method and robot is the marking of company logos and other graphic element outlines onto flat roofs and industrial/commercial floors. However, the concept of the present invention can be used in (substantially) the same way to mark graphic elements onto roads, airfields and sports grounds.

### REFERENCE SIGNS

10 Surface site
11 Outline
12 Robot
13 Reflector
14 Wheel
15 Touchscreen panel
16 Laser triangulation sensor
17 Power supply line

1. A method of marking an outline of a graphic element on a surface site such as a roof, floor, road, airfield or sports ground or similar large scale surface, comprising:
preparing outline data representing the outline of the graphic element;
feeding the outline data to a robot, wherein the robot marks the outline of the graphic element on the surface site based on the fed outline data.

2. The method of claim 1 wherein the robot includes position measuring means, the method comprising: measuring the position of the robot on the surface site via the position measuring means.

3. The method of claim 2 the method comprising:
measuring a distance to at least two, landmarks, including reflectors via the position measuring means and/or
measuring an angle defined by the position of the robot as vertex point and at least one pair of landmarks, including reflectors via the position measuring means, wherein at least one of the distance and angle are measured using light including a laser.

4. The method of claim 2, comprising:
determining the position via triangulation, including laser triangulation via the position measuring means, using predetermined positions of at least two, landmarks, including reflectors.

5. The method of claim 1, wherein at least two reflectors are placed on the surface site.

6. The method of claim 1, wherein the largest distance between two points of the outline is at least 1 m, and/or
wherein
an area between the outline is at least 1 m².

7. A method of providing a graphic element comprising:
the method of marking an outline of the graphic element according to claim 1; and
filling an area between the outline with paint.

8. A robot for marking an outline of a graphic element on a surface site such as a roof, floor, road, airfield or sports ground or similar large scale surface, comprising:
an input means for receiving outline data of the graphic element;
a position measuring means including a laser triangulation sensor, for determining the robot position;
an automatic driving unit for moving of the robot along the outline of the graphic element; and
a marking device, including a printing device, for marking the outline on the surface site.

9. The robot of claim 8, wherein a speed of the robot (12) is at least 0.01 m/s.

10. The robot of claim 8, comprising a collision detection unit.

11. The robot of claim 8, comprising: a zero position and zero orientation tool including at least one point laser and/or at least one line laser for initially positioning and orientating the robot on the surface site.

12. The robot of claim 8, comprising: at least one of a display, an input device,
and an interface for transferring data.

13. The robot of claim 8, wherein the driving means comprises at least one of a plurality of wheels including at least one turnable wheel and
at least one electric motor.

14. The robot of claim 9, wherein the speed of the robot is a maximum speed not more than 0.3 m/s.
